(19) United States
(12) Patent Application Publication
(10) Pub. No.: US 2008/0069929 A1
(43) Pub. Date: Mar. 20, 2008

(54) Method specifying the nutritional value of foodstuffs

(76) Inventor: Eric Labouze, Paris (FR)

Correspondence Address: CLARK & BRODY, 1090 VERMONT AVENUE, NW, SUITE 250, WASHINGTON, DC, 20005, US

(21) Appl. No.: 11/806,026

(22) Filed: May 29, 2007

(30) Foreign Application Priority Data
May 30, 2006 (EP) 06290868.6

(51) Int. Cl. A23P 1/00

(52) U.S. Cl. 426/383

(57) ABSTRACT

A method of grading the nutritional quality of a foodstuff based on latter's formulation involves defining a weighting factor for at least some of the nutrients or groups of nutrients, which are contained in the ingredients of the formulation of said foodstuff and of which the consumption should be reduced or enhanced. Grading of the nutrients to be either reduced or enhanced is done using positive grades based on nutritionally recommended threshold and negative grades based on consumption thresholds observed contemporarily in a reference population. The positive and negative grades are summed to produce a composite grade indicative of the foodstuff nutritional value.

The objective of the present invention is to specify foodstuff nutritional value.

Foodstuffs deemed nutritionally similar and substitutable by the consumer are presently stored on the same store shelves, for instance in supermarkets.

An “ingredient” is defined as any substance, inclusive food additives, used in making or preparing foodstuffs and present in the final foodstuff.

A “nutrient” is defined as any organic or inorganic compound, or element contained in the foodstuffs, that way may be used by the organism in the absence of digestive transformation in order to be assimilated by the cells.

Nutrient labeling displays the differences between foodstuffs: they all contain carbohydrates, lipids and proteins.

Moreover the lists of ingredients and of nutrients are not consumer friendly.

There are already simple grading systems based on a-priori defined nutritional profiles to meet consumer demand for “healthy” foodstuffs: these are the “health(y)” logos on certain foodstuffs, leaving the consumer in the dark about other foodstuffs lacking such logos.

Said logos are applicable to some foodstuffs and do not enable the consumer to balance his/her overall food consumption.

Illustratively such logos are:
the British “signposting” created by the Foods Standards Agency to assist the consumer: in selecting healthier foods: http//www.food.gov.uk/foodlabelling/signposting/
PepsiCo's “SmartSpot” namely a logo applied to the healthiest foodstuffs: www.smartstop.com.

There are also a number of grading systems which confer a single aggregate symbol to the foodstuffs and which supposedly reflects the food's health grade.

Such grading systems' information is fairly unsatisfactory because advantages and drawbacks are summed into a single aggregate index which may mask significant defects of a particular foodstuff.

The object of the present invention is a foodstuff classification method allowing consumers to improve their foodstuff consumption.

Accordingly the present invention relates to a method rating a foodstuffs nutritional value based on its formulation, said method being characterized by the following stages:

(A) Defining a weighting factor for at least some of the nutrients or groups of nutrients contained in the ingredients of said, foodstuffs formulation and of which the consumption should be increased or decreased. A group of nutrients consists of a list of two or more nutrients which are considered jointly in the weighting stage, for instance vitamins (or minerals, or fatty acids). Said nutrients or groups of nutrients hereafter are termed nutritional value descriptors.

(B) Grading as follows those nutrients of which the consumption should be reduced:

(a) assigning a given positive grade to a nutrient if its presence in the food being considered corresponds to a first case where it is equal to or less than a recommended nutritional threshold,

(b) assigning a given negative grade to a nutrient if its presence in the food corresponds to a second case where it is equal to or more than a contemporary observed consumption in a reference population,

(c) otherwise, assign a grade between the positive grade and the negative grade to a nutrient.

(C) Grading as follows those nutrients of which the consumption should be increased:

(a) assigning a given positive grade to a nutrient if its presence in a given foodstuff corresponds to a first case where it is equal to or exceeds at least one recommended nutritional threshold,

(b) assigning a given negative grade to a nutrient if its presence in a foodstuff corresponds to a second case where it is equal to or less than the contemporary consumption observed in a reference population,

(c) otherwise assigning to a nutrient a grade between the positive and the negative grades.

(D) When some nutrients are dealt with in groups rather than individually, combine the grades of these nutrients into one grade for said group of nutrients.

(E) Separately add the positive grades into one sum S₁ and the negative grades into one sum S₂ while taking into account the weighting factors relating to each descriptor.

(F) Assigning to the foodstuff a composite grade constituted by the sum S₁ and the sum S₂.

Illustratively the selected positive grade is +1 and the selected negative grade is −1.

In the third case the assigned grade may be 0 or else it may be a grade changing between a positive and a negative grade commensurately with the presence of the nutrient in the foodstuff.

Moreover two recommended nutritional thresholds and/or two observed nutritional consumption thresholds may be used, resulting as a function of the case in two possible values of the positive and/or negative grade or in two grade scales when considering proportional grading.

Other features and advantages of the present invention are elucidated in the discussion below relating to the appended drawings.

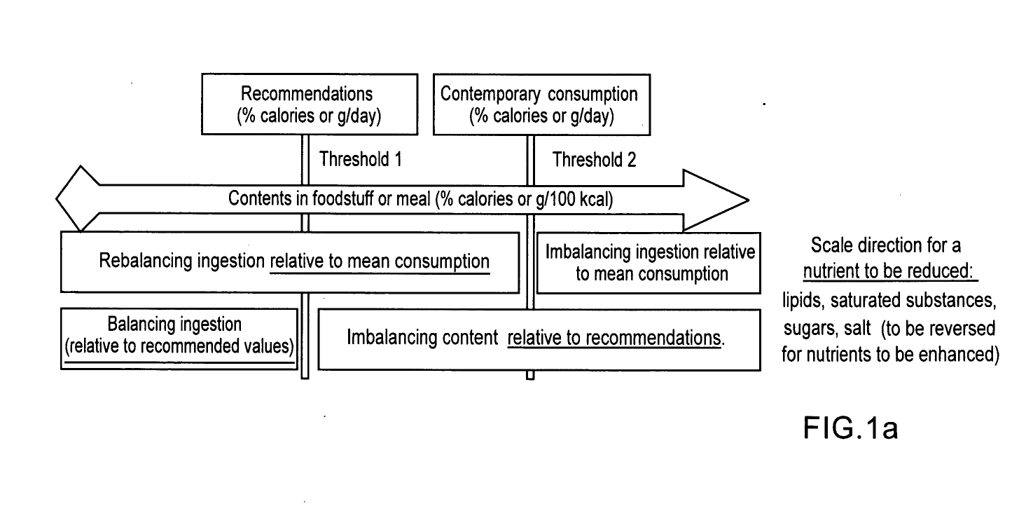

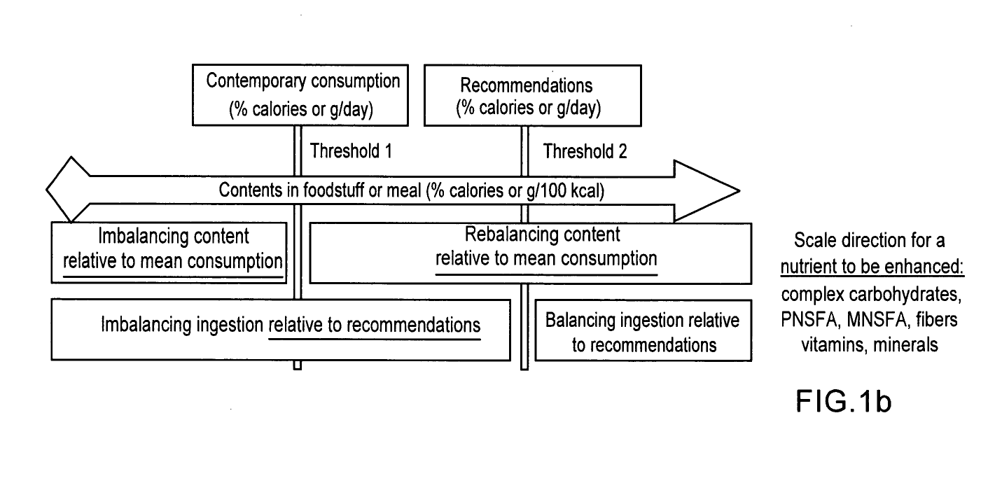

FIGS. 1a, 1b illustrate the grade assigning procedure,

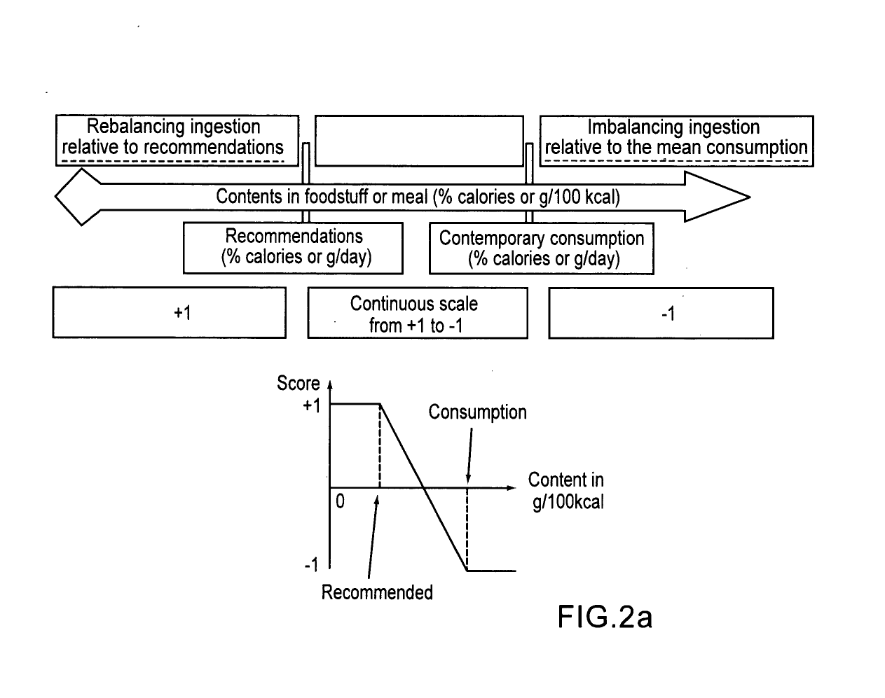

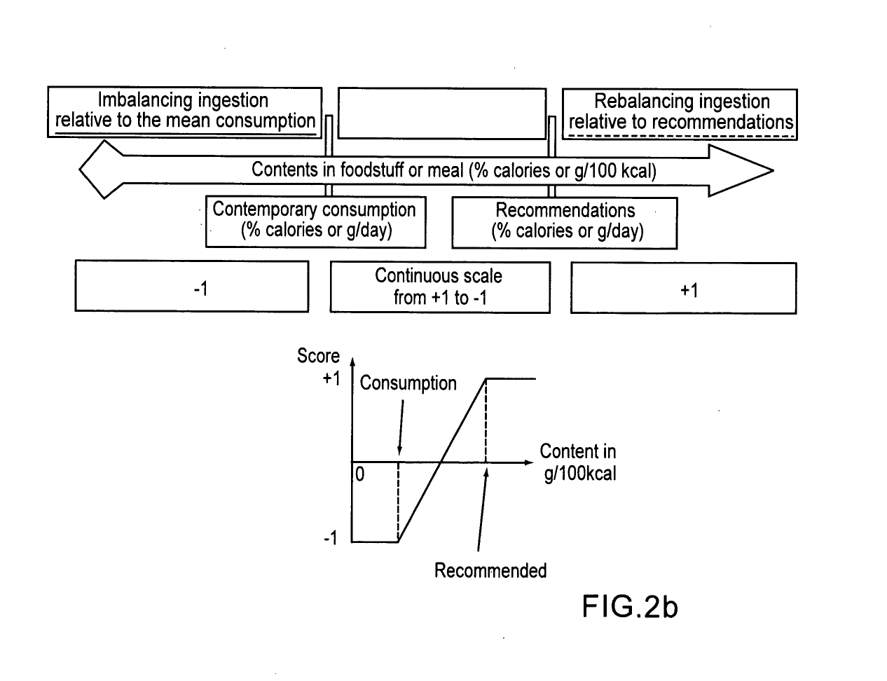

FIGS. 2a, 2b illustrate how to grade continuously,

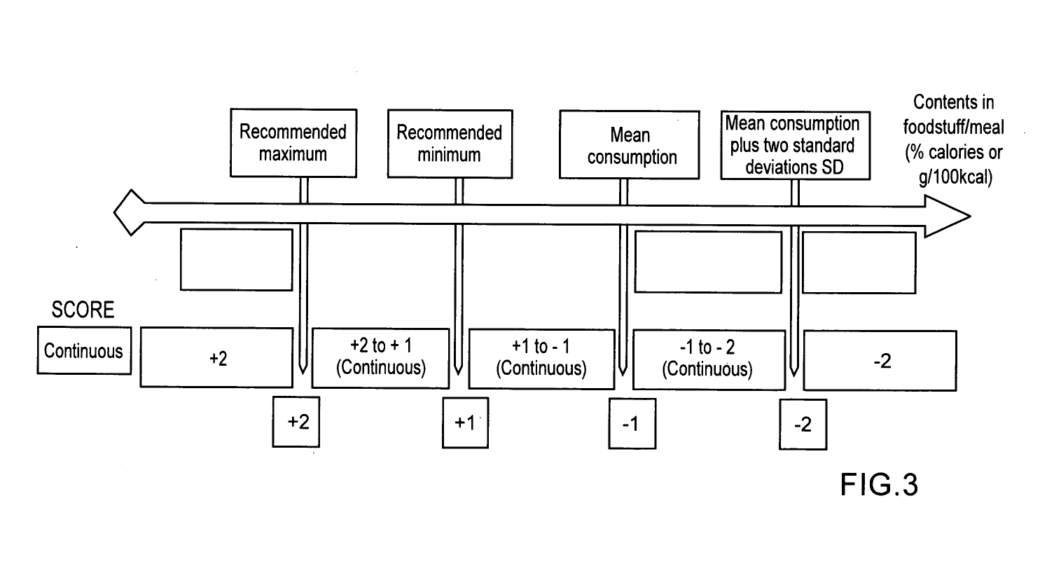

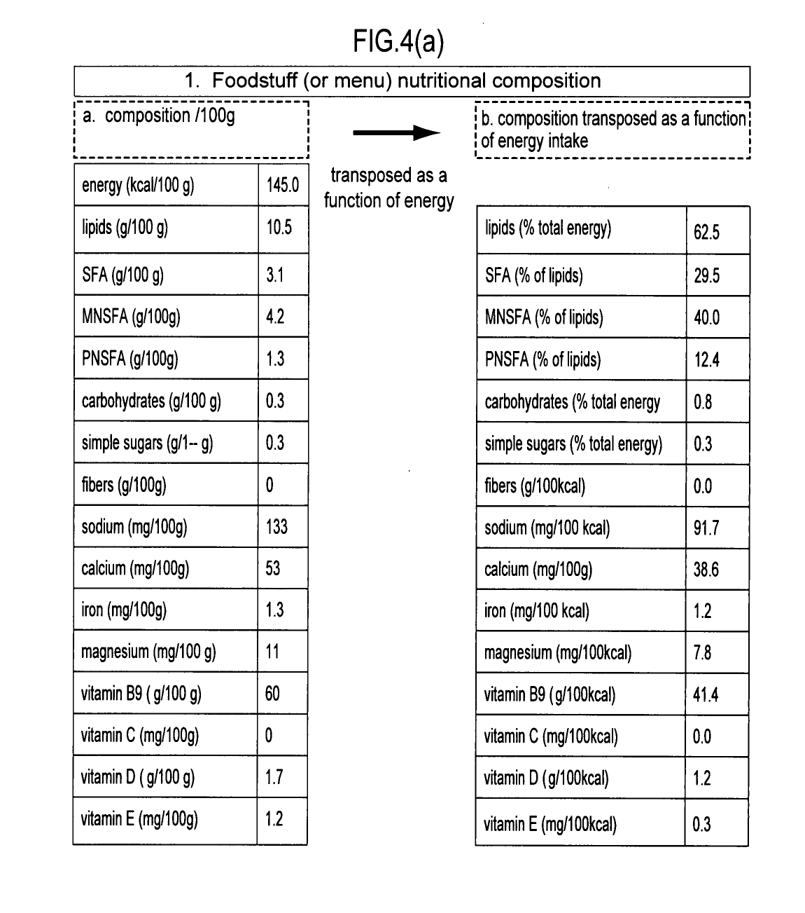

FIG. 3 illustrates multi-threshold grading. FIG. 3 illustrates grading a nutrient of which the consumption is to be reduced. In this FIG. SD denotes standard deviation (for the threshold corresponding to −2). The corresponding threshold of a given nutrient is defined by adding the value of two standard deviations (as defined by the statistics of mean consumption for this population group) to the mean consumption value. In the case the nutrient should be increased, the thresholds are inverted according to the principle of FIGS. 1a and 1b or 2a and 2b, and

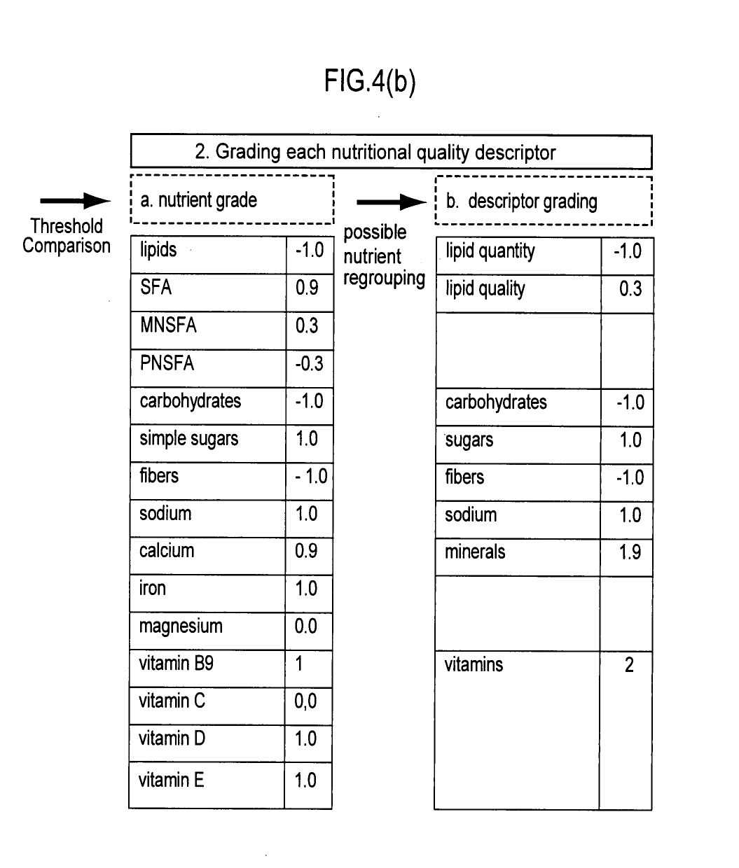

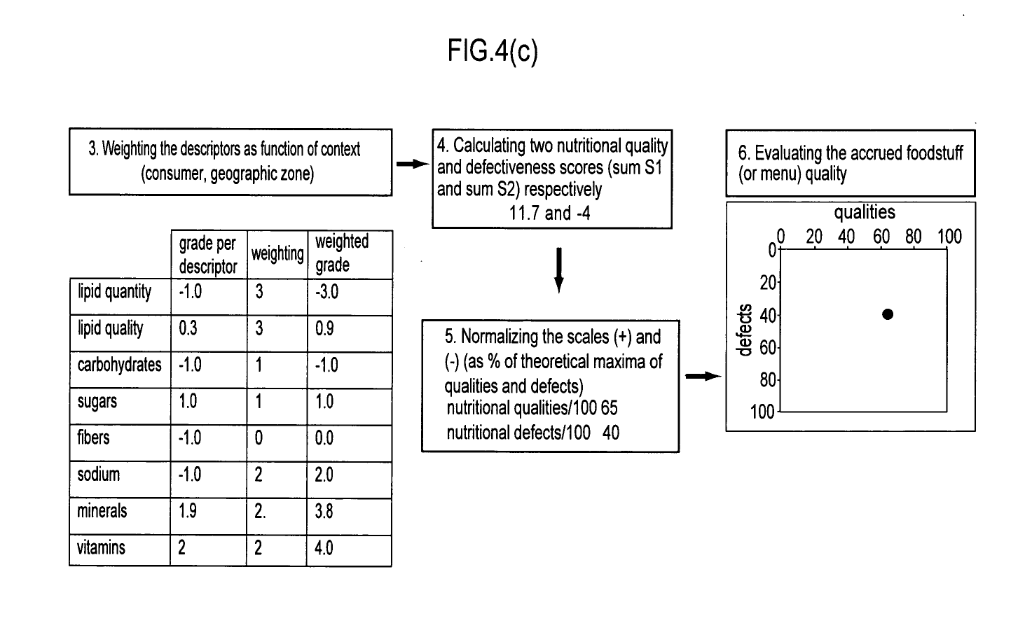

FIG. 4 shows the sequence of the method of the present invention.

The trend of government regulation is to limit nutritional and health claims frequently advanced for advertising purposes whereas present regulations do allow making nutritional or health claims for foodstuffs which are devoid of desirable nutritional profiles.

Present-day trends are to ramp up regulation for instance to preclude health claims such as “high calcium content” for a foodstuff high in fats or such claims as a foodstuff with high sugar and/or slat contents being “low-fat” (see Draft of European Community's regulation of 16 Jul. 2003 regarding nutritional and health claims made for foodstuffs).

This draft calls for restricting nutritional and health claims according to the nutritional product profile to the contents in saturated fats, in transfatty acids, in sugars and in sodium.

Scientific research does show a link between high consumption of these nutrients and some chronic illnesses such as cardiovascular disease, diabetes, cancers, obesity, osteoporosis, dental problems.

While benefits are expected from the new regulation regarding health, consumer food selection and the definition of industrial regulations, nevertheless no means will be available yet that technically specify foodstuffs relative to their health impacts and that are easily mastered by the consumer or that might easily be applied by the foodstuff designers.

The following discussion indicates how the foodstuffs are presently graded, as shown in a number of typical articles:
Mike O'NEILL, “Traffic lights for food?” (National Consumer council—London—June 2004) proposes an aggregate index based on several models of which two are preferred to classify a food as being unhealthy. Accordingly this aggregate index precludes classifying all the foods.
“Criteria for the nutritional evaluation of foods” (Netherlands Nutrition Center—2005) [www.voedingscentrum.nl] advises against binary foodstuff classification discriminating between healthy and unhealthy foodstuffs. This article precludes a significant index.
Adam DREWNOWSKI “Concept of a nutritious food: toward a nutrient density score”, American Journal of Clinical Nutrition 2005, 82, pp 721-732 (American Society for Clinical Nutrition) opposes a score (NNR=Naturally Nutrient Rich) taking into account the ratio of nutrients and the calories content (relative to the standard 2,000 kcal/d) while ignoring the presence of undesirable nutrients. 14 nutrients are considered: protection by calcium, iron, vitamins A, B12, C, D, E, thiamine, riboflavin, folate (vitamin B), non-saturated fats, potassium and zinc.
This aggregate index precludes satisfactory food classification.
“Composite Index for Aggregating Nutrient Density Using Food Labels: Ratio of Recommended to Restricted Food Components”, Douglas B. SCHEIDT et al (Journal of Nutrition Education and Behaviour, vol. 36, issue January 2004, article JNE-36-01-13407, pp 35--) proposes a single index which is a ratio of the recommended food nutrients to the undesirable nutrients.
The recommended nutrients are: proteins, fibers, calcium, vitamins A and C, the undesirable nutrients being calories, sugars, cholesterol, saturated fats and sodium.
Even though this index may assist a consumer's selections, it entails the major drawback of the good food properties masking the bad ones.
Lastly SOOWON KIM et al of the Department of Nutrition and Carolina Population Center, University of North Carolina at Chapel Hill, in “The Diet quality Index—International (DQI-I) Provides an Effective Tool for Cross-National Comparison of Diet Quality as Illustrated by China and the United States” (4^{th} International Conference on Dietary Assessment Methods, September 2000, Tucson, Ariz.—pp 3476-3484), propose a composite index allowing operating comparable programs but providing no perspective of use to individual consumers.
Other approaches have been suggested but their solutions are unsatisfactory because a foodstuffs shortcomings may or may not be taken into account or not be explicitly quantified.
Illustratively the following literature is cited:
“Nutrient Profiling Model” from UK Food Standards: http/www.food.gov.uk/healthiereating/nutlab/nutprofmod
“Educational and Technological Innovations required to Enhance the Selection of Desirable Nutrients”, Lachance et al, Clinical Nutrition 5 (6) pp 257-267, 1986
“Towards better choice nutritious food index”, Bazibarich and Ricci, Australian journal of nutrition and dietetics, 1998, 55, pp 10-20.

The present invention proposes a method to specify the nutritiousness of a foodstuff using a two-figure index, said figures separately taking into account the nutritional advantages and shortcomings of the foodstuff being evaluated in the light of official recommendations (regarding daily nutritional ingestions) and in relation to a mean, observed consumption index.

The purpose of said double index (which is easily displayed on a two-axes plot) is to enable, especially the consumer, to synthesize the foodstuff formulation with respect to nutrition and health.

Nutritional recommendations such as RDA define idealized eating habits but obviously actual consumption does not. The complexity of the foodstuffs compositions (foodstuffs, meals) renders them more or less compensating.

The consumer (or the foodstuff designer) should be provided with information acting as a public health reference point in the form of desirable technical data based on listing technical data (its formulation) of such a foodstuff.

The index reflecting the overall nutritional grade of a foodstuff (or a menu) is defined as a function of said foodstuff's (or said menu's) nutritional composition, of the kind of consumer (children, adults . . . ) of the public health objectives in the particular country, and of the species of foodstuffs (cookies, dairy products, prepared food . . . ).

The index is defined by a logic reflecting the gap between the recommended values and the public health objectives expressed as the technical data in the foodstuff formulation while also taking into account the observed mean consumptions for each nutrient.

Each nutrient is assigned a discontinuous or continuous quality grade from a single evaluation scale (−1/0/+1 or −2 to +2).

Each nutrient is weighted according to the species of foodstuffs and the public health objectives (for instance by factors from 0.5 to 3). The weighting factors are defined by a group of world-class experts and are updated every two years.

Finally each foodstuff/meal is assigned two scores, namely a score which reflects the positive nutritional factors and is the sum of the positive scores and a score of the negative nutritional factors which is the sum of the negative scores, without mutual compensation.

Eight descriptors of nutritional quality are taken into account, namely:

1) quantity of the lipids,

2) quality of the liquids,

3) total carbohydrates

4) simple sugars,

5) fibers

6) sodium

7) minerals

8) vitamins.

15 default criteria may be derived:

carbohydrates, sugars, lipids, saturated fatty acids (SFA), mono non-saturated fatty acids (MNSFA), poly-non-saturated fatty acids (PNSFA), fibers, vitamins B9, C, D, E, salt/sodium, calcium, magnesium, iron.

The vitamins and minerals which are being considered are those of which the observed consumption is at odds with the nutritional recommendations (RDA).

To analyze a larger number of foodstuffs, though will less rigor, only 5 basic criteria may be used, namely carbohydrates, sugars, total lipids, SFA, PNSFA.

Be it noted that such grading wholly ignores the proteins which in general are in ample supply and the consumption of which need not be restricted.

Three zones are used for grading (FIG. 1) by means of two thresholds one of which represents the observed, contemporary consumption and the other the nutritional recommendations for a given population group.

Zone 1: the nutrient or descriptor observes the recommended ingestions (the so-called re-balancing ration). It is assigned a positive grade, for instance +1.

Zone 2: the present descriptor or nutrient introduces an imbalance regarding the contemporary, observed consumption (the so-called imbalancing ration). It is assigned a negative grade for instance −1.

Zone 3: this zone falls between zones 1 and 2, a grade of zero, or a grade interpolated between the positive and negative grades, is assigned to it, illustratively pro-rated to the presence of the nutrient.

The thresholds are defined for each nutrient (FIGS. 1a and 1b). A continuous grading may be used, illustratively prorated to the presence of the nutrient. Such grading is illustrated by FIGS. 2a and 2b in the zone between the thresholds of recommended nutrition and of observed consumption.

For each nutrient object of recommended reduced consumption (amount of lipids, saturated fatty acids, sugars, slat), a threshold 1 is determined which corresponds to the recommended values and shall be less than the threshold 2 corresponding to the contemporary consumption (FIG. 1a). For instance regarding the indicator “amount of lipids”, the threshold is 35% of the foodstuff (or of the menu) calories content and the threshold 2 is 37%.

A threshold 1 is defined for a nutrient of which increasing consumption is recommended (total carbohydrates, fibers, mono- and poly-nonsaturated fatty acids, vitamins and minerals), said threshold corresponding to up-to-date consumption which is less than the threshold 2 corresponding to the recommended values (FIG. 1b). In exceptional cases, a negative score may ignored if the involved minerals and vitamins (or some of them) are below the contemporary consumption.

Multi-threshold scales also may be used (FIG. 3).

The weighting nutritional value criteria may be selected as that defined by a group of experts (weighting factors between 0 and 3) as shown in the Table further below.

FIG. 4 illustrates the method's sequences. First the foodstuffs nutritional composition is determined on the basis of the ingredients in its formulation (stage 1a). Each nutrient is stated as a function of the foodstuffs (or the menu's) calories content (stage 1b).

The lipid amount is expressed as a percentage of the calories content of the foodstuff (or menu). The lipids are qualitatively evaluated by determining the % proportion of the total lipid, of saturated fatty acids and of the and mono-nonsaturated fatty acids and poly-nonsaturated fatty acids. As regards fibers, sodium, vitamins and minerals, the quantity of each nutrient is expressed by 100 kcal of the foodstuff (or menu).

TABLE

| | | | total | | | | | |
|---|---|---|---|---|---|---|---|---|
| | Total | Simple | lipids | Lipid | | | | |
| | carbohydrates | sugars | (quantity) | quality | Fibers | Sodium | Minerals | vitamins |
| Cereals, | 2 | 2 | 2 | 2 | 1.5 | 2 | 1 | 1 |
| Leguminous | | | | | | | | |
| plants, | | | | | | | | |
| potatoes and | | | | | | | | |
| derivatives | | | | | | | | |
| (inclusive | | | | | | | | |
| cookies and | | | | | | | | |
| pastry | | | | | | | | |
| Milk, dairy | 1 | 2 | 3 | 2 | 1 | 2 | 3 | 1 |
| foodstuffs, | | | | | | | | |
| cheeses | | | | | | | | |
| Meats, fish, | 1 | 1 | 3 | 3 | 0 | 2 | 2 | 2 |
| eggs | | | | | | | | |
| Fatty | 0 | 0 | 2 | 3 | 0 | 1 | 1 | 2 |
| substances | | | | | | | | |
| and | | | | | | | | |
| oleaginous | | | | | | | | |
| grains | | | | | | | | |
| Fruits, | 2 | 2 | 1 | 1 | 1.5 | 1 | 2 | 3 |
| vegetables | | | | | | | | |
| and | | | | | | | | |
| derivatives, | | | | | | | | |
| including | | | | | | | | |
| juices | | | | | | | | |
| Mixed dishes | 2 | 1 | 2 | 2 | 1.5 | 1 | 1.5 | 1.5 |
| Non-dairy and | 3 | 3 | 2 | 2 | 1 | 1 | 1 | 1 |
| non-cereal | | | | | | | | |
| desserts | | | | | | | | |
| (sweet | | | | | | | | |
| foodstuffs) | | | | | | | | |
| Snacks | 2 | 2 | 2 | 1 | 1.5 | 1 | 1 | 1 |

Thereupon comparing the composition of each nutrient with the corresponding threshold, a grade is attained for each of these nutrients (stage 2a):

Next, in stage 2b, the grading by nutrient is followed by grading by nutritional value descriptors according to the principle below:
lipid amount: equals the lipid nutrient grade
lipid quality:
   if the lipids represent less than 10% of the foodstuff energy, the grade is 0, otherwise the mean of the saturated fatty acids, mono-non-saturated fatty acids, poly-non-saturated fatty acids,
carbohydrates:
if the carbohydrates contain more than 90 % sugars, the grade is minimum (−1), otherwise the grade equals the grade of the carbohydrate nutrient,
sugars: equal to the sugar nutrient grade,
fibers: equal to the fiber nutrient grade,
sodium: equal to the sodium nutrient grade,
minerals: sum of the grades of the calcium, iron and magnesium grades with a maximum of 2,
vitamins: sum of the B9, C, D and E vitamins with a maximum of 2.

Next, in stage 3, a weighting of 3 is applied to the two lipid criteria (quantity and quality), of 1 for the carbohydrates and sugars, 0 for fibers and 2 for sodium, vitamins and minerals.

In stage 4 the foodstuff score is then determined to be +11.7 and −4 and this score be allotted on a two-dimensional scale. The scores may be normalized in stage 5 by calculating the maximum theoretical grades on one hand for the positive score and on the other hand for the negative score while taking into account the weightings and by dividing by these values the scores of stage 4.

In this instance the extreme theoretical grades are 18 for the positive grade and −10 for the negative grade, the difference being due to the cited exception regarding the vitamins and minerals then entailing only a positive or zero grade.

The + score therefore is 11.7/18=65%

The − score therefore is −4/−10=40%

Foodstuffs of one category (for instance cookies, dairy products, prepared meals etc) may be compared by plotting them on the same graph, which provides an instant 2D display of the accruing qualities and of the accruing defects of each foodstuff (stage 6).

Other weightings may be used for other foodstuffs, for instance:

Lipid quantity (3), lipid quality (1), carbohydrates (1), sugars (2), sodium (1), fibers (1.5), minerals (1), vitamins (1) for sweetened (sugared) cookies.

Illustratively the following weights may be used for the group of mixed dishes:

Lipid quantity (1), lipid quality (1) carbohydrates (2), sugars (1) sodium (1) fibers (1.5) minerals (2), vitamins (2).

Illustratively another weighting factor may be defined which ranges from 1 to 3 as shown in the Table below:

| | | TABLE | | | | | | | |
|---|---|---|---|---|---|---|---|---|---|
| | | Recommended Daily Amounts per foodstuff family (scale: 1 to 3) | | | | | | | |
| | | | | | | | | Minerals | |
| | | Available | | | Lipids | Lipid | | (except | |
| Code | Families | carbohydrates | Sugars | Fibers | (quantity) | quality | Salt | salt) | Vitamins |
| 1 | Cereals, | 3.0 | 1.1 | 2.8 | 1.3 | 1.1 | 2.1 | 1.2 | 1.0 |
| | leguminous | | | | | | | | |
| | plants, | | | | | | | | |
| | potatoes and | | | | | | | | |
| | derivatives | | | | | | | | |
| | (among which | | | | | | | | |
| | cookies, | | | | | | | | |
| | pastries, | | | | | | | | |
| | CPAC) | | | | | | | | |
| 2 | Milk, dairy | 1.3 | 1.8 | 1.0 | 1.9 | 2.1 | 1.7 | 3.0 | 1.3 |
| | products, | | | | | | | | |
| | cheeses | | | | | | | | |
| 3 | Meats, fish | 1.0 | 1.0 | 1.0 | 3.0 | 2.9 | 2.5 | 2.5 | 2.8 |
| | and eggs | | | | | | | | |
| 4 | Animal and | 1.0 | 1.1 | 1.1 | 3.0 | 2.8 | 1.0 | 1.1 | 2.4 |
| | vegetal fats, | | | | | | | | |
| | oleaginous | | | | | | | | |
| | grains | | | | | | | | |
| 5 | Fruits, | 1.6 | 2.4 | 3.0 | 1.0 | 1.2 | 1.7 | 1.5 | 2.4 |
| | vegetables | | | | | | | | |
| | and | | | | | | | | |
| | derivatives | | | | | | | | |
| | (among which | | | | | | | | |
| | fruit juices) | | | | | | | | |
| 6 | Mixed dishes | 1.8 | 1.0 | 2.2 | 2.5 | 2.2 | 3.0 | 1.8 | 1.5 |
| 7 | Sweetened | 1.9 | 3.0 | 1.1 | 1.2 | 1.2 | 1.0 | 1.1 | 1.1 |
| | (sugared) | | | | | | | | |
| | foodstuffs | | | | | | | | |
| | without | | | | | | | | |
| | cereals or | | | | | | | | |
| | milk | | | | | | | | |
| 8 | Beverages | 1.9 | 3.0 | 1.1 | 1.0 | 1.0 | 1.1 | 2.7 | 2.5 |
| 9 | Other | 1.1 | 1.0 | 1.1 | 2.4 | 3.0 | 1.6 | 1.0 | 2.1 |

1. A method of grading the nutritional quality of a foodstuff based on latter's formulation, characterized by comprising the following stages:
(A) defining a weighting factor for at least some of the nutrients or groups of nutrients which are contained in the ingredients of the formulation of said foodstuff and of which the consumption should be reduced or enhanced,
(B) grading as follows those nutrients of which consumption should be reduced:
(a) assigning a given positive grade to a nutrient when its presence in the foodstuff under consideration corresponds to a first case of being equal to or below at least one nutritionally recommended threshold,
(b) assigning a given negative grade to a nutrient when its presence in the corresponding foodstuff corresponds to a second case of being equal to or larger than at least one consumption threshold observed contemporarily in a reference population,
(c) if otherwise, assigning a grade between the positive grade and the negative grade.
(C) grading those said nutrients of which the consumption should be enhanced as follows:
(a) assigning a given positive grade to a nutrient if its presence in the foodstuff under consideration corresponds to a first case of being equal to or larger than at least one threshold of nutritional recommendation
(b) assigning a given negative grade to a nutrient if its presence in the foodstuff corresponds to a second case of being equal to or less than at least one threshold of contemporary consumption observed in a reference population,
(c) if otherwise, assigning to a nutrient a grade between the positive grade and the negative grade.
(D) in the case that certain nutrients are not processed separately but in groups, combining the grades into one grade for said group of nutrients.
(E) separately adding the positive grades into a sum S₁ and the negative grades into a sum S₂.
(F) assigning a composite grade which is composed of sum S₁ and the sum S₂.

2. A method as claimed in claim 1, characterized in that the positive grade is +1 and the negative grade is −1.

3. Method as claimed in claim 1, characterized in that in the third case, the grade is 0.

4. Method as claimed in claim 1, characterized in that in the third case the grade changes between the positive grade and the negative grade commensurately with the presence of the nutrient in the foodstuff.

5. Method as claimed in claim 1, characterized in that regarding the quantity of lipids, and/or sugars and/or carbohydrates, the thresholds are defined as percentages of the total calories content.

6. Method as claimed in claim 1, characterized in that regarding the vitamins and/or minerals, the percentage of the daily quantities are taken into account per 100 kcal.

7. Method as claimed in claim 1, characterized in that regarding the quantity of lipid, the thresholds are defined as percentages of saturated fatty acids and mono-non-saturated fatty acids.

8. Method as claimed in claim 1, characterized in that there are two recommended nutritional thresholds and two positive grade values.

9. Method as claimed in claim 1, characterized in that there are two observed consumption thresholds and two values of negative grades.
